(19) United States
(12) Patent Application Publication
(10) Pub. No.: US 2018/0367240 A1
(43) Pub. Date: Dec. 20, 2018

(54) METHOD AND APPARATUS FOR TRANSMITTING AND RECEIVING DATA IN COMMUNICATION SYSTEM

(71) Applicant: Samsung Electronics Co., Ltd, Suwon-si (KR)

(72) Inventors: Duk-Gu SUNG, Seoul (KR); Hyeon-Mok KO, Hwaseong-si (KR); Yong-Tae KIM, Suwon-si (KR)

(21) Appl. No.: 16/062,593

(22) PCT Filed: Dec. 14, 2016
(86) PCT No.: PCT/KR16/14665

§ 371 Date: Jun. 14, 2018

(30) Foreign Application Priority Data
Dec. 14, 2015 (KR) 10-2015-0178420

(51) Int. Cl. H04L 1/00; H04L 12/26

(52) U.S. Cl. CPC H04L 1/0017; H04L 43/0894; H04L 43/0829; H04L 43/10

(57) ABSTRACT

The present disclosure relates to a method and an apparatus for transmitting and receiving data in accordance with a transmission mode in a communication system. A method for transmitting data by a transmitter in a communication system, according to the present disclosure, comprises the steps of: transmitting a probe message to a receiver on the basis of at least one transmission mode of a multicast transmission mode and a unicast transmission mode; receiving a reception report message including status information of a network from the receiver; determining a transmission mode of one of the multicast transmission mode and the unicast transmission mode on the basis of the reception report message; and transmitting the data to the receiver on the basis of the determined transmission mode.

### CROSS-REFERENCE TO RELATED APPLICATIONS AND CLAIM OF PRIORITY

This application is a 371 of PCT International Application No. PCT/KR2016/014665 filed on Dec. 14, 2016, which claims priority to Korean Patent Application No. 10-2015-0178420 filed on Dec. 14, 2015, the disclosures of which are herein incorporated by reference in their entirety.

### BACKGROUND

### 1. Field

The present disclosure generally relates to a method and apparatus for transmitting and receiving data according to a transmission mode in a communication system.

### 2. Description of Related Art

The Internet has evolved from a human-oriented connection network, in which humans generate and consume information, to the Internet of Things (IoT), in which distributed elements such as objects exchange and process information. Internet-of-Everything (IoE) technology may be an example of a combination of IoT technology and big-data processing technology via connection with a cloud server.

In order to implement the IoT, technical factors such as a sensing technology, wired/wireless communication and network infrastructure, a service interface technology, a security technology, and the like are required, and thus research is being conducted on a sensor network, Machine-to-Machine (M2M) communication, Machine-Type Communication (MTC), and the like for connection between objects.

In an IoT environment, via collection and analysis of data generated in connected objects, an Internet Technology (IT) service that creates new value in people's lives may be provided. IoT may be applied to fields such as those of a smart home, a smart building, a smart city, a smart car or connected car, a smart grid, health care, smart home appliance, a high-tech medical service, or the like, via the convergence of the conventional Information Technology (IT) and various industries.

A data transmission method executed between devices in a communication system may include a one-to-one (1:1) data transmission method and a one-to-many (1:N) data transmission method. Here, the 1:N data transmission method is a method in which a single transmitter transmits the same data to a plurality of receivers. The 1:N data transmission method may be applied to real-time screen and voice sharing, a multilateral video call (push-to-talk: PTT), and the like.

When a conventional transmitter transmits data according to the 1:N data transmission method, data may be transmitted based on a unicast transmission mode or a multicast transmission mode, as shown in FIGS. 1 and 2.

FIG. 1 is a diagram illustrating an example of a unicast transmission mode applied in a communication system, and FIG. 2 is a diagram illustrating an example of a multicast transmission mode applied in a communication system.

Referring to FIG. 1, when the transmitter 110 transmits data to N receivers 150-1 to 150-N, based on the unicast transmission mode, the transmitter 110 needs to transmit the same data N times so as to perform data transmission to N receivers 150-1 to 150-N. Referring to FIG. 2, when the transmitter 110 transmits data to N receivers 150-1 to 150-N, based on the multicast transmission mode, the transmitter 110 needs to transmit the same data to N receivers 150-1 to 150-N at one time.

Therefore, when the single transmitter 110 transmits data based on the unicast transmission mode, the amount of network usage increases in proportion to the number of receivers, and thus the network may become congested. The congested network may cause drawbacks, such as packet loss, an increase in delay time, and the like, and may become a factor that decreases service quality as perceived by a user. When the transmitter 110 is a mobile terminal, the congested network may also affect battery life.

Conversely, when the transmitter 110 transmits data based on the multicast transmission mode, the amount of network usage may be constant irrespective of the number of receivers. The multicast transmission mode may not perform data retransmission in a medium access control (MAC) layer. Therefore, packet restoration is generally executed in an application layer, so as to perform reliable data transmission in the multicast transmission mode. Therefore, additional overhead is needed for restoring lost packets, and thus when a packet loss rate is high in a network and a small number of receivers exists, the unicast transmission mode is more efficient than the multicast transmission mode. In the multicast transmission mode, multicast may show different performance according to the type of Access Point (AP). Accordingly, before the multicast transmission mode is used, multicast performance and configurations need to be checked for each manufacturing company.

Therefore, there is a desire for a method of efficiently transmitting and receiving data, irrespective of a network state, a packet loss rate, AP performance and the like in a communication system.

### SUMMARY

According to aspects of the present disclosure, a method and apparatus for transmitting and receiving data according to a transmission mode in a communication system are provided.

According to aspects of the present disclosure, a method and apparatus for transmitting and receiving data based on state information of a receiver in a communication system are provided.

In accordance with an aspect of the present disclosure, a method of transmitting data by a transmitter in a communication system is provided, wherein the method includes: transmitting a probe message to a receiver, based on at least one transmission mode selected from among a multicast transmission mode and a unicast transmission mode; receiving a reception report message including network state information from the receiver; determining a transmission mode selected from among the multicast transmission mode and the unicast transmission mode, based on the reception report message; and transmitting data to the receiver, based on the determined transmission mode.

In accordance with an aspect of the present disclosure, a method of receiving data from a transmitter by one of a plurality of receivers in a communication system is provided, wherein the method includes: receiving a probe message, based on at least one transmission mode selected from among a multicast transmission mode and a unicast transmission mode; transmitting a reception report message including network state information measured when the probe message is received; and receiving data transmitted based on a transmission mode determined based on the reception report message.

In accordance with an aspect of the present disclosure, an apparatus for transmitting data in a transmitter in a communication system is provided, wherein the apparatus includes: a transceiving unit configured to transmit and receive data; and a controller configured to perform control so as to: transmit a probe message, based on at least one transmission mode selected from among a multicast transmission mode and a unicast transmission mode; receive a reception report message including network state information; determine a transmission mode selected from among the multicast transmission mode and the unicast transmission mode, based on the reception report message; and transmit the data based on the determined transmission mode.

In accordance with an aspect of the present disclosure, an apparatus for receiving data from a transmitter in one of a plurality of receivers in a communication system is provided, wherein the apparatus includes: a transceiving unit, configured to transmit and receive data; and a controller, configured to perform control so as to: receive a probe message based on at least one transmission mode selected from among a multicast transmission mode and a unicast transmission mode; transmit a reception report message including network state information measured when the probe message is received; and receive data transmitted based on a transmission mode which is determined according to the reception report message.

Other aspects, gains, and core features of the present disclosure are processed along with additional drawings, and they are apparent to those skilled in the art from the following detailed description including exemplary embodiments of the present disclosure.

The terms “include”, “comprise”, and derivatives thereof may mean inclusion without limitation, the term “or” may have an inclusive meaning and means “and/or”, the phrases “associated with”, “associated therewith”, and derivatives thereof may mean to include, be included within, interconnect with, contain, be contained within, connected to or with, coupled to or with, be communicable with, cooperate with, interleave, juxtapose, be proximate to, be bound to or with, have, and have a property of, the term “controller” may mean any device, system, or a part thereof that controls at least one operation, and such a device may be implemented in hardware, firmware, or software, or some combinations of at least two of the same. It should be noted that the functionality associated with any particular processor may be centralized or distributed, whether locally or remotely. Definitions for certain words and phrases are provided throughout this patent document, those skilled in the art should understand that in many, if not most instances, such definitions apply to prior, as well as future uses of such defined words and phrases.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a diagram illustrating an example of a unicast transmission mode applied in a communication system;

FIG. 2 is a diagram illustrating an example of a multicast transmission mode applied in a communication system;

FIG. 3 is a diagram illustrating an example of the configuration of a communication system according to an embodiment of the present disclosure;

FIG. 4 is a diagram illustrating an example of a data transmission/reception method performed between a transmitter and a plurality of receivers in a communication system according to an embodiment of the present disclosure;

FIG. 5 is a diagram illustrating an example of a method of receiving data by a receiver in a communication system according to an embodiment of the present disclosure;

FIG. 6 is a diagram illustrating an example of a method of transmitting data by a transmitter in a communication system according to an embodiment of the present disclosure;

FIG. 7 is a diagram illustrating another example of a data transmission/reception method performed between a transmitter and a plurality of receivers in a communication system according to an embodiment of the present disclosure;

FIG. 8 is a diagram illustrating another example of a method of receiving data by a receiver in a communication system according to an embodiment of the present disclosure;

FIG. 9 is a diagram illustrating another example of a method of transmitting data by a transmitter in a communication system according to an embodiment of the present disclosure;

FIG. 10 is a diagram illustrating another example of a method of transmitting data by a transmitter in a communication system according to an embodiment of the present disclosure;

FIG. 11 is a diagram illustrating the internal configuration of a transmitter that transmits data in a communication system according to an embodiment of the present disclosure; and

FIG. 12 is a diagram illustrating the internal configuration of a receiver that receives data in a communication system according to an embodiment of the present disclosure.

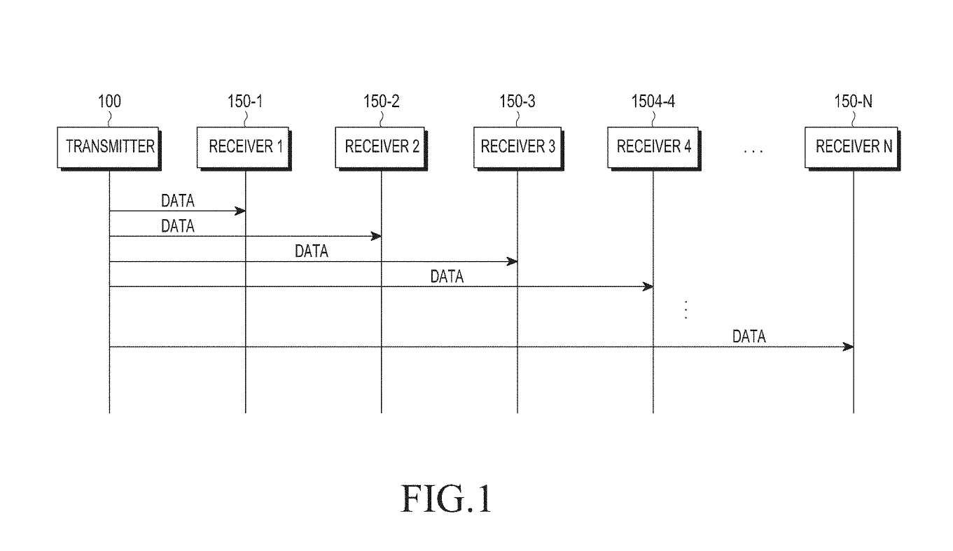

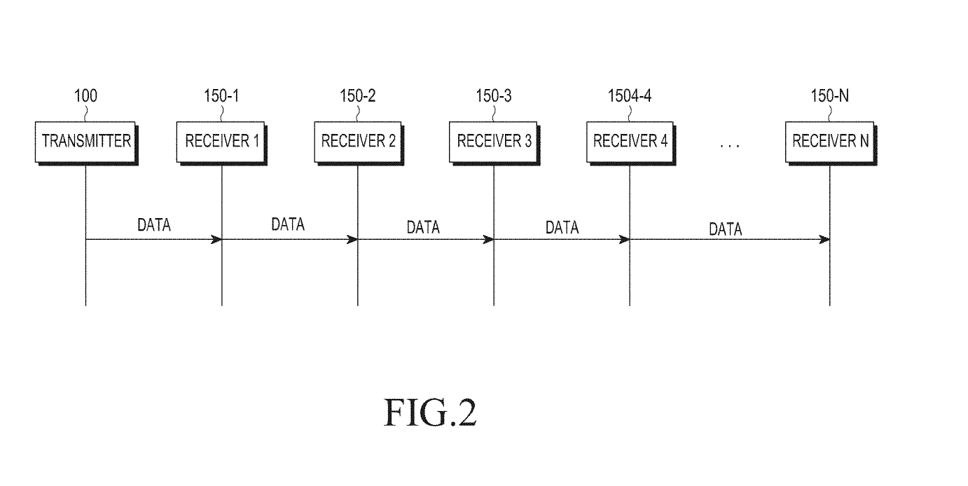

It should be construed that like reference numerals are used for illustrating the same or similar elements, features, and structures, throughout the above drawings.

### DETAILED DESCRIPTION

The following detailed described that refers to the accompanying drawings help in comprehensively understanding various embodiments of the present disclosure defined by the claims and the equivalents thereof. Although the following detailed description includes various specific concrete explanations to assist with understanding, they are considered to be only examples. Accordingly, those skilled in the art may recognize that various modifications and changes of the various embodiments described herein can be made without departing from the range and scope of the present disclosure. Further, descriptions of the known functions and elements can be omitted for clarity and brevity.

The terms and words used in the following detailed description and the claims are not limited to literal meanings, and are simply used for helping obtain a clear and consistent understanding of the present disclosure of the disclosure. Therefore, it should be apparent to those skilled in the art that the following description of various embodiments of the present disclosure is provided for illustrative purposes only, and is not intended to limit the present disclosure that is defined by the appended claims and equivalents thereof.

Further, it will be appreciated that singular expressions such as “an” and “the” include plural expressions as well, unless the context clearly indicates otherwise. Accordingly, as an example, a “component surface” includes one or more component surfaces.

Although the terms including an ordinal number such as first, second, etc. can be used for describing various elements, the structural elements are not restricted by the terms. The terms are used merely for the purpose to distinguish an element from the other elements. For example, a first element could be termed a second element, and similarly, a second element could be also termed a first element without departing from the scope of the present disclosure. As used herein, the term “and/or” includes any and all combinations of one or more associated items.

The terms used herein are used only to describe particular embodiments, and are not intended to limit the present disclosure. As used herein, the singular forms are intended to include the plural forms as well, unless the context clearly indicates otherwise. In the present disclosure, the terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Unless defined otherwise, all terms used herein, including technical and scientific terms, have the same meaning as commonly understood by those of skill in the art to which the present disclosure pertains. Such terms as those defined in a generally used dictionary are to be interpreted to have the meaning equal to the contextual meaning in the relevant field of art.

An embodiment of the present disclosure may provide a method of determining a transmission mode used for data transmission to each receiver, based on state information of each receiver, irrespective of a network state, a packet loss rate, AP performance, and the like in a communication system, and of transmitting data based on the determined transmission mode.

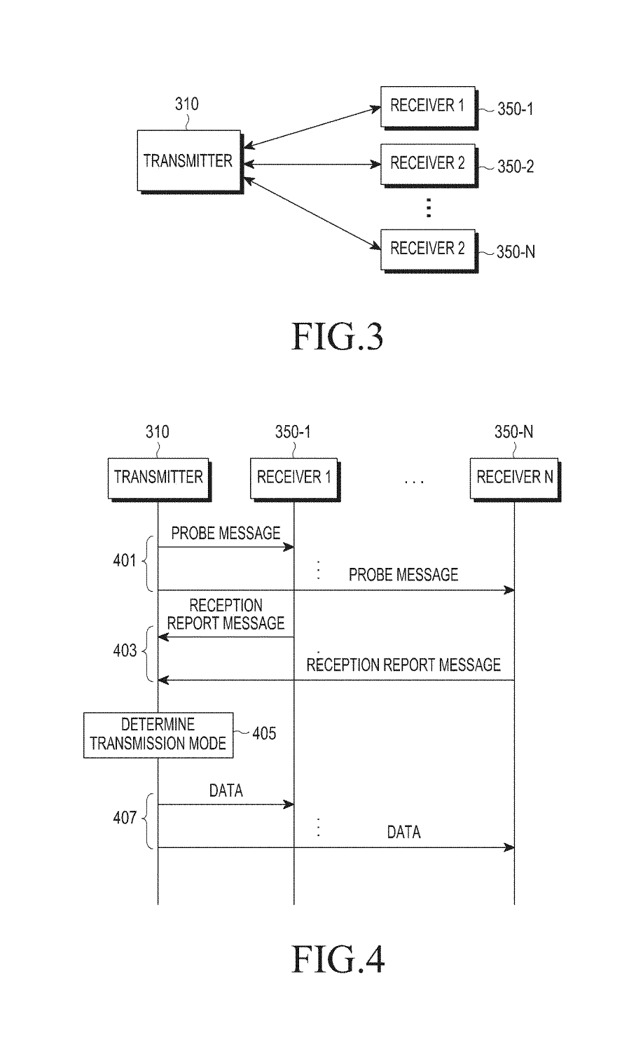

FIG. 3 is a diagram illustrating an example of the configuration of a communication system according to an embodiment of the present disclosure.

Referring to FIG. 3, a transmitter 310 transmits a probe message to each of a plurality of receivers 350-1, 350-2, . . . , and 350-N, based on at least one transmission mode selected from among a multicast transmission mode and a unicast transmission mode in the communication system. Here, although FIG. 3 illustrates the case in which three or more receivers 350-1, 350-2, . . . , and 350-N exist, the embodiment of the present disclosure is applied to all communication systems in which two or more receivers exist. The probe message may include original data that the transmitter 310 desires to transmit, or may include data previously defined for the probe message.

Each of the plurality of receivers 350-1, 350-2, . . . , and 350-N transmits, to the transmitter 310, a reception report message which includes network state information measured when the probe message is received. Here, the network state information may include at least one piece of information selected from among information related to a packet loss rate, information associated with a received data rate, information associated with a time at which the probe message is received, and information associated with a time at which the reception report message is transmitted.

Subsequently, the transmitter 310 determines a transmission mode for transmitting data to each of the plurality of receivers 350-1, 350-2, . . . , and 350-N, based on the reception report message received from each of the plurality of receivers 350-1, 350-2, . . . , and 350-N. The transmitter 310 may transmit desired original data, based on the transmission mode determined for each of the plurality of receivers 350-1, 350-2, . . . , and 350-N.

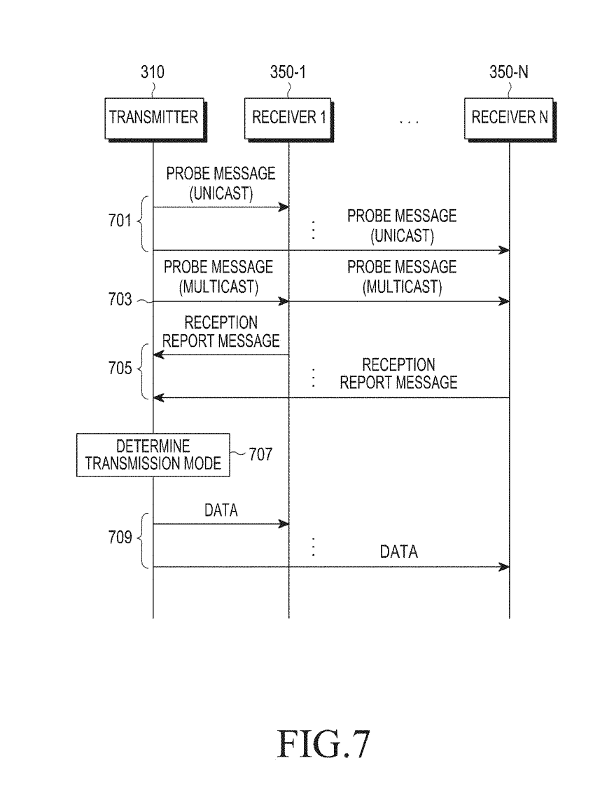

Methods by which the transmitter 310 determines a transmission mode may be variously implemented according to operation of the transmitter 310 and the plurality of receivers 350-1, 350-2, . . . , and 350-N. Hereinafter, the methods in which the transmitter 310 determines a transmission mode according to operation of the transmitter 310 and the plurality of receivers 350-1, 350-2, . . . , and 350-N will be described. That is, an example of determining a transmission mode by the transmitter 310 will be described in detail with reference to FIGS. 4 to 6. Another example of determining a transmission mode by the transmitter 310 will be described in detail with reference to FIGS. 7 to 10.

FIG. 4 is a diagram illustrating an example of a data transmission/reception method performed between a transmitter and a plurality of receivers in a communication system according to an embodiment of the present disclosure.

Referring to FIG. 4, the transmitter 310 transmits a probe message to each of the plurality of receivers 350-1, 350-2, . . . , and 350-N, based on a transmission mode that is initially set in a communication system, in operation 401. In this instance, the probe message may include original data that the transmitter 310 desires to transmit, or may include data previously defined for the probe message.

Each of the plurality of receivers 350-1, 350-2, . . . , and 350-N measures network state information when a probe message transmitted based on the initially set transmission mode is received, and transmits, to the transmitter 310, a reception report message which includes the measured network state information in operation 403. Here, the network state information may include at least one piece of information selected from among information related to a packet loss rate, information associated with a received data rate, information associated with the time at which the probe message is received, and information associated with the time at which the reception report message is transmitted.

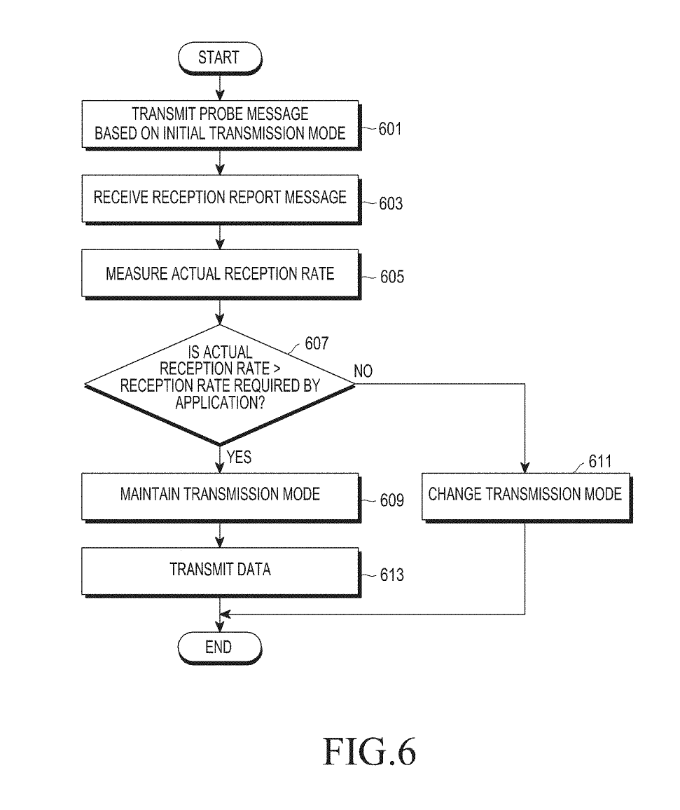

Subsequently, the transmitter 310 determines a transmission mode for transmitting data to each of the plurality of receivers 350-1, 350-2, . . . , 350-N as shown in FIG. 6, based on the reception report message received from each of the plurality of receivers 350-1, 350-2, . . . , and 350-N in operation 405. The transmitter 310 transmits data, based on the transmission mode determined for each of the plurality of receivers 350-1, 350-2, . . . , and 350-N, in operation 407.

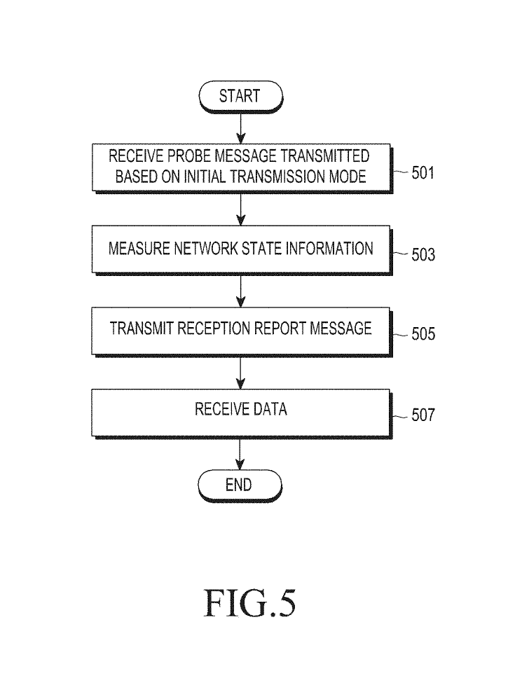

FIG. 5 is a diagram illustrating an example of a method of receiving data by a receiver of a communication system according to an embodiment of the present disclosure.

Referring to FIG. 5, one of the plurality of receivers 350-1, 350-2, . . . , and 350-N receives, from the transmitter 310, a probe message transmitted based on a transmission mode that is initially set in the communication system in operation 501. The receiver measures network state information when the probe message is received in operation 503. Here, the network state information may include at least one piece of information selected from among information related to a packet loss rate, information associated with a received data rate, information associated with the time at which the probe message is received, and information associated with the time at which the reception report message is transmitted. In this instance, the receiver may monitor a data packet, or may measure the information associated with the received data rate and the information associated with the packet loss rate, based on buffer information of a network interface card.

The receiver transmits, to the transmitter 310, a reception report message including the measured network state information in operation 505. Accordingly, in operation 507, the receiver may receive, from the transmitter 310, data transmitted based on a transmission mode, which is determined based on the reception report message transmitted from the receiver. The method in which the transmitter 310 determines the transmission mode according to the reception report message will be described in detail with reference to FIG. 6.

FIG. 6 is a diagram illustrating an example of a method of transmitting data by a transmitter in a communication system according to an embodiment of the present disclosure.

Referring to FIG. 6, the transmitter 310 transmits a probe message to each of the plurality of receivers 350-1, 350-2, . . . , and 350-N based on a transmission mode that is initially set in a communication system in operation 601. In operation 603, the transmitter 310 receives, from each of the plurality of receivers 350-1, 350-2, . . . , and 350-N, a reception report message which includes network state information measured when the probe message transmitted based on the initially set transmission mode is received. Here, the network state information may include at least one piece of information selected from among information related to a packet loss rate, information associated with a received data rate, information associated with the time at which the probe message is received, and information associated with the time at which the reception report message is transmitted.

In operation 605, the transmitter 310 measures an actual reception rate (actual receiving rate) at which the probe message is received, based on the network state information included in the reception report message, for each of the plurality of receivers 350-1, . . . , and 350-N. For example, the transmitter 310 may measure an actual reception rate by taking into consideration information associated with a packet loss rate and information associated with a received data rate from among network state information included in the reception report message, as shown in Equation 1 provided below.

actual reception rate=received data rate−additional data rate required for packet restoration [Equation 1]

Here, the additional data rate required for the packet restoration may be calculated according to a lost packet restoration method using information associated with a packet loss rate (e.g., a retransmission method and forward error correction (FEC) method).

In operation 607, the transmitter 310 may determine whether the measured actual reception rate satisfies the reception rate required by a current application. When the measured actual reception rate satisfies the reception rate required by the current application (i.e., when the measured actual reception rate is equal to or greater than the reception rate required by the current application), the transmitter 310 may maintain the current transmission mode in operation 609. That is, when the measured actual reception rate satisfies the reception rate required by the current application, the transmitter 310 may determine to transmit data based on the multicast transmission mode when the current transmission mode is the multicast transmission mode, and may determine to transmit data based on the unicast transmission mode when the current transmission mode is the unicast transmission mode. Conversely, when the measured actual reception rate does not satisfy the reception rate required by the current application (i.e., when the measured actual reception rate is less than the reception rate required by the current application), the transmitter 310 may change the current transmission mode to another transmission mode in operation 611. That is, when the measured actual reception rate does not satisfy the reception rate required by the current application, the transmitter 310 may determine to transmit data based on the unicast transmission mode when the current transmission mode is the multicast transmission mode, and may determine to transmit data based on the multicast transmission mode when the current transmission mode is the unicast transmission mode.

Accordingly, the transmitter 310 may transmit data based on the transmission mode determined for each of the plurality of receivers 350-1, 350-2, . . . , 350-N in operation 613.

An example of the data transmission/reception method performed between the transmitter 310 and each of the plurality of receivers 350-1, . . . , and 305-N has been described in the above description. Hereinafter, another example of the data transmission/reception method performed between the transmitter 310 and each of the plurality of receivers 350-1, . . . , and 305-N will be described.

In another example of the data transmission/reception method performed between the transmitter 310 and each of the plurality of receivers 350-1, . . . , and 305-N, a method in which the transmitter 310 determines a transmission mode includes configuring a separate probe message and monitoring network state information. Another example of the data transmission/reception method performed between the transmitter 310 and each of the plurality of receivers 350-1, . . . , and 305-N in the communication system will be described in detail with reference to FIGS. 7 to 10.

FIG. 7 is a diagram illustrating another example of a data transmission/reception method performed between a transmitter and a plurality of receivers in a communication system according to an embodiment of the present disclosure.

Referring to FIG. 7, the transmitter 310 transmits a probe message to each of the plurality of receivers 350-1, . . . , and 305-N based on the unicast transmission mode in operation 701, and transmits a probe message to each of the plurality of receivers 350-1, . . . , and 305-N, based on the multicast transmission mode in operation 703. The probe message transmitted based on the unicast transmission mode and the probe message transmitted based on the multicast transmission mode are separately defined messages.

Each of the plurality of receivers 350-1, . . . , and 305-N measures network state information when the probe message transmitted based on the unicast transmission mode is received, and may measure network state information when the probe message transmitted based on the multicast transmission mode is received. Each of the plurality of receivers 350-1, 350-2, . . . , and 350-N transmits, to the transmitter 310, a reception report message which includes network state information measured when the probe message transmitted based on the unicast transmission mode is received and network state information measured when the probe message transmitted based on the multicast transmission mode is received in operation 703. Here, the network state information may include at least one piece of information selected from among information related to a packet loss rate, information associated with a received data rate, information associated with the time at which the probe message is received, and information associated with the time at which the reception report message is transmitted.

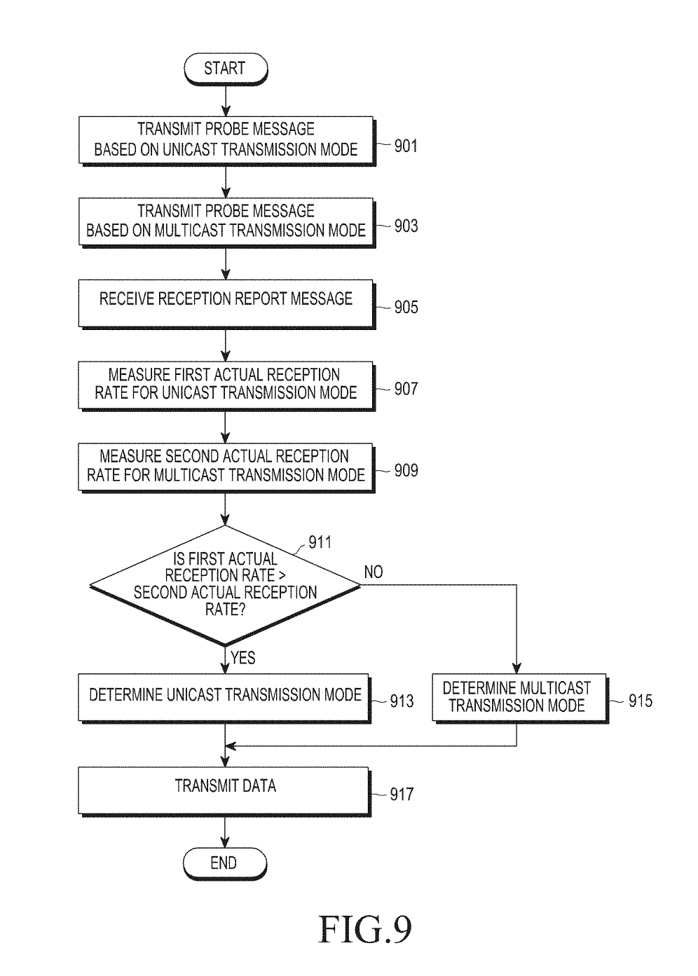

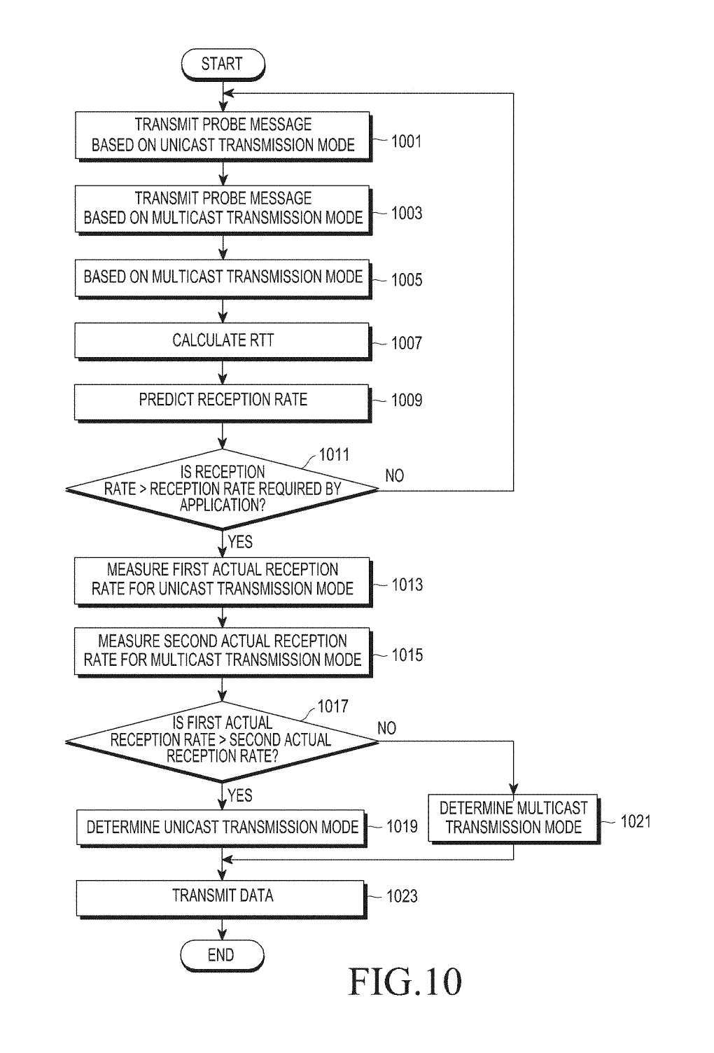

Subsequently, the transmitter 310 may determine a transmission mode for transmitting data to each of the plurality of receivers 350-1, 350-2, . . . , and 350-N as shown in FIGS. 9 and 10 based on the reception report message received from each of the plurality of receivers 350-1, 350-2, . . . , and 350-N in operation 707. The transmitter 310 may transmit original data, based on the transmission mode determined for each of the plurality of receivers 350-1, 350-2, . . . , and 350-N, in operation 709.

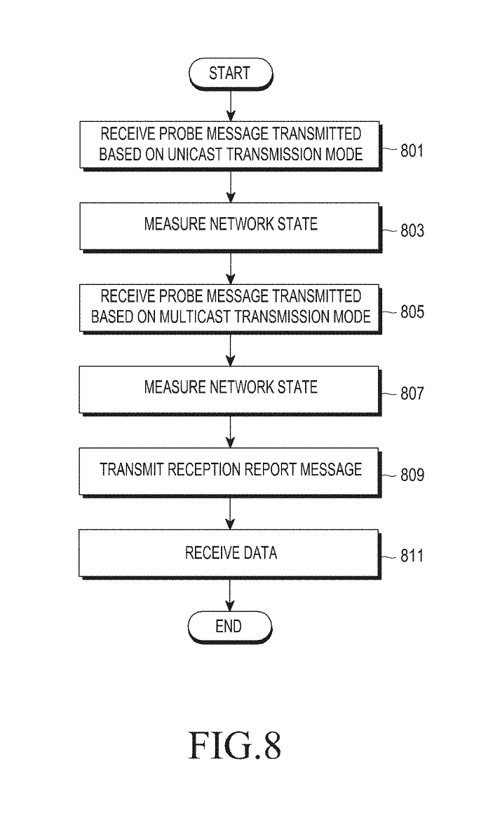

FIG. 8 is a diagram illustrating another example of a method of receiving data by a receiver in a communication system according to an embodiment of the present disclosure.

Referring to FIG. 8, one of the plurality of receivers 350-1, 350-2, . . . , and 350-N receives, from the transmitter 310, a probe message transmitted based on the unicast transmission mode in operation 801. The receiver measures network state information when the probe message transmitted based on the unicast transmission mode is received in operation 803. Also, the receiver receives a probe message transmitted based on the multicast transmission mode from the transmitter 310 in operation 805. The receiver measures network state information when the probe message transmitted based on the multicast transmission mode is received in operation 807. Here, the network state information may include at least one piece of information selected from among information related to a packet loss rate, information associated with a received data rate, information associated with the time at which the probe message is received, and information associated with the time at which the reception report message is transmitted. In this instance, the receiver may monitor a data packet, or may measure the information associated with a received data rate and the information associated with a packet loss rate based on buffer information of a network interface card.

In operation 809, the receiver transmits, to the transmitter 310, a reception report message which includes the network state information measured when the probe message transmitted based on the unicast transmission mode is received and the network state information measured when the probe message transmitted based on the multicast transmission mode is received in operation 809.

Accordingly, in operation 811, the receiver may receive, from the transmitter 310, data transmitted based on a transmission mode, which is determined based on the reception report message transmitted from the receiver. The method in which the transmitter 310 determines the transmission mode according to the reception report message will be described in detail with reference to FIGS. 9 and 10.

FIG. 9 is a diagram illustrating another example of a method of transmitting data by a transmitter in a communication system according to an embodiment of the present disclosure.

Referring to FIG. 9, the transmitter 310 transmits a probe message to each of the plurality of receivers 350-1, . . . , and 350-N based on the unicast transmission mode in operation 901, and transmits a probe message to each of the plurality of receivers 350-1, . . . , and 350-N based on the multicast transmission mode in operation 903. The transmitter 310 may receive, from each of the plurality of receivers 350-1, . . . , and 350-N, a reception report message which includes network state information measured when the probe message transmitted based on the unicast transmission mode is received and network state information measured when the probe message transmitted based on the multicast transmission mode is received in operation 905. Here, the network state information may include at least one piece of information selected from among information related to a packet loss rate, information associated with a received data rate, information associated with the time at which the probe message is received, and information associated with the time at which the reception report message is transmitted.

In operation 907, the transmitter 310 measures a first actual reception rate (first actual receiving rate), based on the network state information, which is measured when the probe message transmitted based on the unicast transmission mode is received and which is included in the reception report message received from each of the plurality of receivers 350-1, . . . , and 305-N. In operation 909, the transmitter 310 measures a second actual reception rate (second actual receiving rate), based on the network state information, which is measured when the probe message transmitted based on the multicast transmission mode is received and which is included in the reception report message received from each of the plurality of receivers 350-1, . . . , and 305-N. In this instance, the transmitter 310 may measure the first actual reception rate and the second actual reception rate using Equation 1.

The transmitter 310 determines whether the measured first actual reception rate has a higher value than the second actual reception rate in operation 911. When the measured first actual reception rate has a higher value than the second actual reception rate, the transmitter 310 determines a transmission mode for transmitting data as the unicast transmission mode in operation 913. When the measured first actual reception rate has a lower value than the second actual reception rate, the transmitter 310 may determine a transmission mode for transmitting the data as the multicast transmission mode in operation 915. When the measured first actual reception rate and the second actual reception rate are the same, the transmission mode may be determined as one of the multicast transmission mode and the unicast transmission mode, which may efficiently perform data transmission, based on the environment or configuration of the communication system. The transmitter 310 may transmit data based on the transmission mode determined for each of the plurality of receivers 350-1, 350-2, . . . , 350-N in operation 917.

The method of determining a transmission mode by the transmitter 310 has been briefly described with reference to FIG. 9, and the method of determining the transmission mode described in FIG. 9 may be executed in detail as described in FIG. 10.

FIG. 10 is a diagram concretely illustrating another example of a method of transmitting data by a transmitter in a communication system according to an embodiment of the present disclosure. An example of the method of determining a transmission mode which will be described with reference to FIG. 10 may be applied to the method of determining a transmission mode which has been described with reference to FIG. 6.

Referring to FIG. 10, the transmitter 310 transmits a probe message to each of the plurality of receivers 350-1, . . . , and 350-N based on the unicast transmission mode in operation 1001, and transmits a probe message to each of the plurality of receivers 350-1, . . . , and 350-N based on the multicast transmission mode in operation 1003. The transmitter 310 may receive, from each of the plurality of receivers 350-1, . . . , and 350-N, a reception report message which includes network state information measured when the probe message transmitted based on the unicast transmission mode is received and network state information measured when the probe message transmitted based on the multicast transmission mode is received in operation 1005. Here, the network state information may include at least one piece of information selected from among information related to a packet loss rate, information associated with a received data rate, information associated with the time at which the probe message is received, and information associated with the time at which the reception report message is transmitted.

When the transmitter 310 configures and transmits a separate probe message, the received data rate may not be accurate. To this end, the transmitter 310 may calculate the value of a Round Trip Time (RTT) based on the received reception report message in operation 1007. Accordingly, in the communication between a terminal and an AP, most of the time is expended by AP's queueing delay, and thus the transmitter 310 may predict a data reception rate using the calculated value of the RTT in operation 1009.

The transmitter 310 determines whether the predicted reception rate satisfies the reception rate required by an application in operation 1011. When the predicted reception rate does not satisfy the reception rate required by the application, the transmitter 310 returns to operation 1001 again, and periodically transmits a probe message. Conversely, when the predicted reception rate satisfies the reception rate required by the application, the transmitter 310 measures a first actual reception rate, based on the network state information, which is measured when the probe message transmitted based on the unicast transmission mode is received and which is included in the reception report message received from each of the plurality of receivers 350-1, . . . , and 305-N, in operation 1013. In operation 1015, the transmitter 310 may measure a second actual reception rate, based on the network state information, which is measured when the probe message transmitted based on the multicast transmission mode is received and which is included in the reception report message received from each of the plurality of receivers 350-1, . . . , and 305-N. In this instance, the transmitter 310 may measure the first actual reception rate and the second actual reception rate using Equation 1.

The transmitter 310 determines whether the measured first actual reception rate has a higher value than the second actual reception rate in operation 1017. When the measured first actual reception rate has a higher value than the measured second actual reception rate, the transmitter 310 determines a transmission mode for transmitting data as the unicast transmission mode in operation 1019. When the measured first actual reception rate has a lower value than the measured second actual reception rate, the transmitter 310 determines a transmission mode for transmitting the data as the multicast transmission mode in operation 1021. When the measured first actual reception rate and the measure second actual reception rate are the same, the transmission mode may be determined as one of the multicast transmission mode and the unicast transmission mode that may efficiently perform data transmission based on the environment or configuration of the communication system. The transmitter 310 transmits data based on the transmission mode determined for each of the plurality of receivers 350-1, 350-2, . . . , and 350-N in operation 1023.

Therefore, when the transmitter performs 1:N data transmission using an AP in the communication system according to an embodiment of the present disclosure, data may be transmitted according to the optimal transmission mode determined based on network state information.

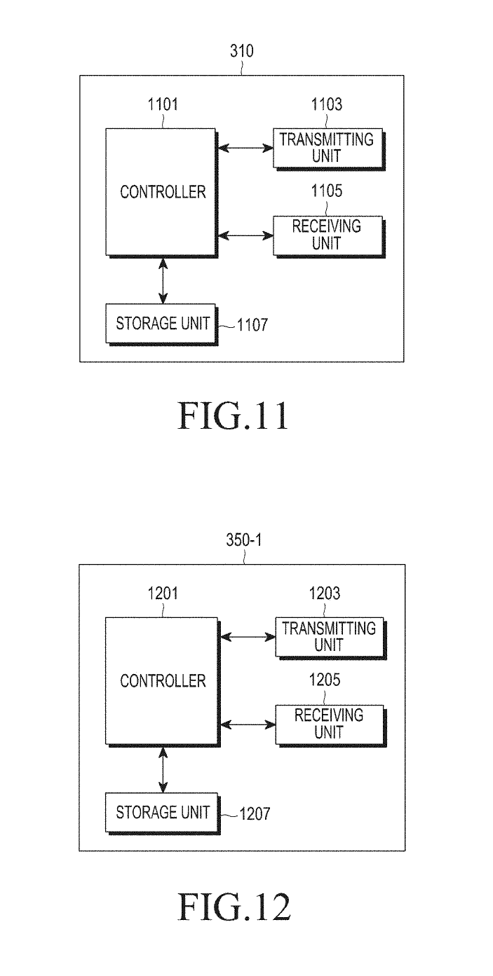

Examples of a data transmission/reception method performed between the transmitter 310 and each of the plurality of receivers 350-1, . . . , and 350-N in the communication system according to an embodiment have been described. Subsequently, with reference to FIGS. 11 and 12, the internal configurations of the transmitter 310 and the plurality of receivers 350-1, . . . , and 350-N, which perform data transmission and reception, will be described.

FIG. 11 is a diagram illustrating the internal configuration of a transmitter that transmits data in a communication system according to an embodiment of the present disclosure.

Referring to FIG. 11, the transmitter 310 includes a controller 1101, a transmitting unit 1103, a receiving unit 1105, and a storage unit 1107.

The controller 1101 controls the overall operation of the transmitter 310, and particularly controls operations related to transmitting data according to an embodiment of the present disclosure. The operations related to transmitting data according to an embodiment of the present disclosure are the same as those described in FIGS. 4, 6, 7, 9, and 10, and thus a detailed description thereof will be omitted.

The transmitting unit 1103 receives various signals and various messages from other entities included in the communication system according to the control of the controller 1101. Here, various signals and various messages received by the transmitting unit 1103 are the same as those described in FIGS. 4, 6, 7, 9, and 10, and thus a detailed description thereof will be omitted.

Also, the receiving unit 1105 receives various signals and various messages from other entities included in the communication system under the control of the controller 1101. Here, various signals and various messages received by the receiving unit 1105 are the same as those described in FIGS. 4, 6, 7, 9, and 10, and thus a detailed description thereof will be omitted.

The storage unit 1107 may store programs, various data, or the like in association with the operations, which are related to transmitting data according to an embodiment of the present disclosure and are executed by the transmitter 310, under the control of the controller 1101. Further, the storage unit 1107 stores various signals and various messages received from the other entities by the receiver 1105.

Meanwhile, although FIG. 11 illustrates that the transmitter 310 is implemented as separate units such as the controller 1101, the transmitting unit 1103, the receiving unit 1105, and the storage unit 1107, the transmitter 310 may be implemented in the form in which at least two of the controller 1101, the transmitting unit 1103, the receiving unit 1105, and the storage unit 1107 are integrated. Also, the transmitter 310 may be implemented as a single processor.

FIG. 12 is a diagram illustrating the internal configuration of a receiver that receives data in a communication system according to an embodiment of the present disclosure. Although FIG. 12 illustrates the internal configuration of the receiver 350-1 from among the plurality of receivers 350-1, . . . , and 350-N, the internal configurations of other receivers are configured to be the same as the configuration of the receiver 350-1.

Referring to FIG. 12, the receiver 350-1 includes a controller 1201, a transmitting unit 1203, a receiving unit 1205, and a storage unit 1207.

The controller 1201 controls the overall operation of the receiver 350-1, and particularly, controls operations related to receiving data according to an embodiment of the present disclosure. The operations related to receiving data according to an embodiment of the present disclosure are the same as those described in FIGS. 4, 5, 7, 8, and 10, and thus a detailed description thereof will be omitted.

The transmitting unit 1203 receives various signals and various messages from other entities included in the communication system under the control of the controller 1201. Here, various signals and various messages received by the transmitting unit 1203 are the same as those described in FIGS. 4, 5, 7, and 8, and thus a detailed description thereof will be omitted.

The receiving unit 1205 receives various signals and various messages from other entities included in the communication system under the control of the controller 1201. The various signals and the various messages received by the receiving unit 1205 are the same as those described in FIGS. 4, 5, 7, and 8, and thus a detailed description thereof will be omitted herein.

The storage unit 1207 may store programs, various data, or the like in association with the operations, which are related to receiving data according to an embodiment of the present disclosure, and are executed by the receiver 350-1, under the control of the controller 1201. Also, the storage unit 1207 stores various signals and various messages that the receiver 1205 receives from the other entities.

Meanwhile, although FIG. 12 illustrates that the receiver 350-1 is implemented as separate units, such as the controller 1201, the transmitting unit 1203, the receiving unit 1205, and the storage unit 1207, the receiver 350-1 may be implemented in a form in which at least two of the controller 1201, the transmitting unit 1203, the receiving unit 1205, and the storage unit 1207 are integrated. Also, the receiver 350-1 may be implemented as a single processor.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the aforementioned embodiments, but should be defined by the appended claims and equivalents thereof.

1. A method of transmitting data by a transmitter in a communication system, the method comprising:
transmitting to a receiver, a probe message based on at least one transmission mode selected from among a multicast transmission mode and a unicast transmission mode;
receiving, from the receiver, a reception report message including network state information;
obtaining a transmission mode selected from among the multicast transmission mode and the unicast transmission mode, based on the reception report message; and
transmitting to the receiver, data based on the obtained transmission mode.

2. The method of claim 1, wherein the network state information comprises at least one of information selected from among information associated with a packet loss rate, information associated with a received data rate, information associated with a time at which the probe message is received, or information associated with a time at which the reception report message is transmitted.

3. The method of claim 1, wherein transmitting, to the receiver, the probe message to the comprises: transmitting the probe message, based on the multicast transmission mode when a transmission mode initially set in the communication system is the multicast transmission mode; and transmitting the probe message, based on the unicast transmission mode when the initially set transmission mode is the unicast transmission mode, and
wherein the determining obtaining the transmission mode comprises: obtaining a reception rate of the receiver, based on information associated with a packet loss rate and information associated with a received data rate which are included in the reception report message; and obtaining the initially set transmission mode as the transmission mode for transmitting the data when the reception rate of the receiver has a higher value than a reception rate required by an application, and obtaining a transmission mode different from the initially set transmission mode as the transmission mode for transmitting the data when the reception rate of the receiver has a lower value than the reception rate required by the application, and
wherein the reception rate of the receiver is obtained based on a difference between the information associated with the received data rate and the information associated with the packet loss rate.

4. The method of claim 1, wherein transmitting to the receiver, the probe message comprises:
transmitting the probe message, based on the multicast transmission mode; and
transmitting the probe message, based on the unicast transmission mode, and
wherein the reception report message comprises first network state information, obtained when the probe message transmitted based on the multicast transmission mode is received, and second network state information, obtained when the probe message transmitted based on the unicast transmission mode is received.

5. The method of claim 4, wherein obtaining the transmission mode comprises:
obtaining a first reception rate of the receiver, based on the first network state information;
obtaining a second reception rate of the receiver, based on the second network state information;
obtaining the transmission mode for transmitting data as the multicast transmission mode when the first reception rate has a higher value than the second reception rate; and
obtaining the transmission mode for transmitting data as the unicast transmission mode when the first reception rate has a lower value than the second reception rate.

6. The method of claim 4, wherein obtaining determining the transmission mode comprises:
obtaining a value of a round trip time (RTT), based on the reception report message, and predicting a reception rate of the receiver using the value of the RTT;
obtaining a first reception rate of the receiver, based on the first network state information when the reception rate of the receiver has a higher value than a reception rate required by an application;
obtaining a second reception rate of the receiver, based on the second network state information;
obtaining the transmission mode for transmitting data as the multicast transmission mode when the first reception rate has a higher value than the second reception rate; and
obtaining the transmission mode for transmitting data as the unicast transmission mode when the first reception rate has a lower value than the second reception rate.

7. A method of receiving data from a transmitter by one of a plurality of receivers in a communication system, the method comprising:
receiving a probe message, based on at least one transmission mode selected from among a multicast transmission mode and a unicast transmission mode;
transmitting a reception report message including network state information obtained when the probe message is received; and
receiving data transmitted based on a transmission mode obtained based on the reception report message.

8. The method of claim 7, wherein the network state information comprises at least one of information selected from among information associated with a packet loss rate, information associated with a received data rate, information associated with a time at which the probe message is received, or information associated with a time at which the reception report message is transmitted, and
wherein receiving the probe message comprises: receiving the probe message transmitted based on the multicast transmission mode when a transmission mode initially set in the communication system is the multicast transmission mode; and receiving the probe message transmitted based on the unicast transmission mode when the initially set transmission mode is the unicast transmission mode, and
wherein receiving the data comprises: receiving data transmitted based on the initially set transmission mode when a reception rate of the receiver, which is obtained based on the information associated with the packet loss rate and the information associated with the received data rate, which are included in the reception report message, is higher than a reception rate required by an application; and receiving data transmitted based on a transmission mode different from the initially set transmission mode when the reception rate of the receiver has a lower value than the reception rate required by the application, and
wherein the reception rate of the receiver is obtained based on a difference between the information associated with the received data rate and the information associated with the packet loss rate.

9. The method of claim 7, wherein receiving the probe message comprises:
receiving a probe message transmitted based on the multicast transmission mode; and
receiving a probe message transmitted based on the unicast transmission mode, and
wherein the reception report message comprises first network state information, obtained when the probe message transmitted based on the multicast transmission mode is received, and second network state information, obtained when the probe message transmitted based on the unicast transmission mode is received.

10. The method of claim 9, wherein receiving the data comprises:
receiving data transmitted based on the multicast transmission mode when a first reception rate of the receiver, obtained based on the first network state information, has a higher value than a second reception rate of the receiver, obtained based on the second network state information; and
receiving data transmitted based on the unicast transmission mode when the first reception rate has a lower value than the second reception rate.

11. The method of claim 9, wherein, when a reception rate of the receiver, which is predicted using a value of a round trip time (RTT) obtained based on the reception report message, has a higher value than a reception rate required by an application, the receiving the data comprises:
receiving data transmitted based on the multicast transmission mode when a first reception rate of the receiver, obtained based on the first network state information, has a higher value than a second reception rate of the receiver, obtained based on the second network state information; and
receiving data transmitted based on the unicast transmission mode when the first reception rate has a smaller value than the second reception rate.

12. An apparatus for transmitting data in a transmitter in a communication system, the apparatus comprising:
a transceiver; and
a controller configured to:
control the transceiver to transmit a probe message, based on at least one transmission mode selected from among a multicast transmission mode and a unicast transmission mode;
control the transceiver to receive a reception report message including network state information;
obtain a transmission mode selected from among the multicast transmission mode and the unicast transmission mode, based on the reception report message; and
control the transceiver to transmit the data based on the obtained transmission mode.

13. The apparatus of claim 12, wherein the network state information comprises at least one of information selected from among information associated with a packet loss rate, information associated with a received data rate, information associated with a time at which the probe message is received, or information associated with a time at which the reception report message is transmitted.

14. An apparatus for receiving, from a transmitter, data in one of a plurality of receivers in a communication system, the apparatus comprising:
a transceiver; and
a controller configured to control the transceiver to:
receive a probe message based on at least one transmission mode selected from among a multicast transmission mode and a unicast transmission mode;
transmit a reception report message including network state information obtained when the probe message is received; and
receive data transmitted based on a transmission mode which is obtained according to the reception report message.

15. The apparatus of claim 14, wherein the network state information comprises at least one of information selected from among information associated with a packet loss rate, information associated with a received data rate, information associated with a time at which the probe message is received, or information associated with a time at which the reception report message is transmitted, and
wherein the controller is further configured to control the transceiver to:
receive the probe message transmitted based on the multicast transmission mode when a transmission mode initially set in the communication system is the multicast transmission mode;
and receive the probe message transmitted based on the unicast transmission mode when the initially set transmission mode is the unicast transmission mode, and receive data transmitted based on the initially set transmission mode when a reception rate of the receiver, which is obtained based on the information associated with the packet loss rate and the information associated with the received data rate, which are included in the reception report message, is higher than a reception rate required by an application; and receive data transmitted based on a transmission mode different from the initially set transmission mode when the reception rate of the receiver has a lower value than the reception rate required by the application, and
wherein the reception rate of the receiver is obtained based on a difference between the information associated with the received data rate and the information associated with the packet loss rate.

16. The apparatus of claim 12, wherein the controller is further configured to
control the transceiver to transmit the probe message, based on the multicast transmission mode when a transmission mode initially set in the communication system is the multicast transmission mode; and transmit the probe message, based on the unicast transmission mode when the initially set transmission mode is the unicast transmission mode; and
obtain a reception rate of a receiver, based on information associated with a packet loss rate and information associated with a received data rate which are included in the reception report message; and obtain the initially set transmission mode as the transmission mode for transmitting the data when the reception rate of the receiver has a higher value than a reception rate required by an application, and obtain a transmission mode different from the initially set transmission mode as the transmission mode for transmitting the data when the reception rate of the receiver has a lower value than the reception rate required by the application, and
wherein the reception rate of the receiver is obtained based on a difference between the information associated with the received data rate and the information associated with the packet loss rate.

17. The apparatus of claim 12, wherein the controller is further configured to control the transceiver to:
transmit the probe message, based on the multicast transmission mode; and
transmit the probe message, based on the unicast transmission mode, and
wherein the reception report message comprises first network state information, obtained when the probe message transmitted based on the multicast transmission mode is received, and second network state information, obtained when the probe message transmitted based on the unicast transmission mode is received.

18. The apparatus of claim 17, wherein the controller is further configured to:
obtain a first reception rate of a receiver, based on the first network state information;
obtain a second reception rate of the receiver, based on the second network state information;
obtain the transmission mode for transmitting data as the multicast transmission mode when the first reception rate has a higher value than the second reception rate; and
obtain the transmission mode for transmitting data as the unicast transmission mode when the first reception rate has a lower value than the second reception rate.

19. The apparatus of claim 17, wherein the controller is further configured to:
obtain a value of a round trip time (RTT), based on the reception report message, and predicting a reception rate of a receiver using the value of the RTT;
obtain a first reception rate of the receiver, based on the first network state information when the reception rate of the receiver has a higher value than a reception rate required by an application;
obtain a second reception rate of the receiver, based on the second network state information;
obtain the transmission mode for transmitting data as the multicast transmission mode when the first reception rate has a higher value than the second reception rate; and
obtain the transmission mode for transmitting data as the unicast transmission mode when the first reception rate has a lower value than the second reception rate.

20. The apparatus of claim 14, wherein the controller is further configured to control the transceiver to:
receive a probe message transmitted based on the multicast transmission mode; and
receive a probe message transmitted based on the unicast transmission mode, and
wherein the reception report message comprises first network state information, obtained when the probe message transmitted based on the multicast transmission mode is received, and second network state information, obtained when the probe message transmitted based on the unicast transmission mode is received.
